(19) United States
(12) Patent Application Publication
(10) Pub. No.: US 2004/0115525 A1
(43) Pub. Date: Jun. 17, 2004

(54) Structure of an electrical tool

(76) Inventor: Li Jen Kuo, Taipei (TW)

Correspondence Address: Li Jen Kuo, PO Box 82-144, Taipei, TW

(21) Appl. No.: 10/319,510

(22) Filed: Dec. 16, 2002

(51) Int. Cl. H01M 2/00

(52) U.S. Cl. 429/163

(57) ABSTRACT

A structure of an electrical tool is disclosed. The electrical tool comprises a housing mounted with a driving device for coupling with a tool connector, and having a control switch for controlling the switching of the driving device, characterized in that a compartment for containing a power source device is provided to the housing, and one side of the housing is positioned with a battery cover for easy replacement of the power source device, and one side of the housing is a protruded button for slidably mounting onto a belt clip, and the driving device is a gear module with a motor to drive the gear module, and one side of the gear module is provided with a tool mount extended beyond the external of the housing for the coupling of the tool connector, and the tool connector is secured with a positioning gear and the housing is mounted with a positioning block for engagement with the positioning gear, and one end of the positioning block is protruded at the external side of the housing. The combination of the positioning block and the positioning gear allows the electrical tool to be operated manually if current supply is failed or insufficient.

### CROSS-REFERENCE

This invention is related to U.S. patent application Ser. No. 09/588,668.

### BACKGROUND OF THE INVENTION

(a) Technical Field of the Invention

The present invention relates to electrical tool, and in particular, to an electrical tool which can be operated manually when current supply to the tool is failed or insufficient.

(b) Description of the Prior Art

Conventional electrical tool, as shown in FIG. 1, comprises a housing 1, a control switch 2 connected with a plurality of wires 10, a driving device 3 and a power source device 4. This conventional tool is not convenient when carry along in a tool bag for the reason that the power source device 4 is a re-chargeable battery 40 connected to an AC socket 41. It is inconvenient to separate the AC socket 41 from the battery seat containing the rechargeable battery. Besides, re-charging of the battery may not efficient if the battery is partially changed.

U.S. Pat. Nos. 3,941,618 discloses electric-driven tool which is filled with batteries, and U.S. Pat. No. 4,075,402, and 5,845,986, disclose battery connecting structure. These structures provide the convenience of using batteries to operate the tools, however, the tools cannot be placed conveniently within a tool box. Besides, if there is a shortage of batteries, these tools cannot be manually operated.

### SUMMARY OF THE INVENTION

Accordingly, it is an object of the present invention to provide a structure of an electrical tool, comprising a housing mounted with a driving device for coupling with a tool connector, and having a control switch for controlling the switching of the driving device, characterized in that a compartment for containing a power source device is provided to the housing, and one side of the housing is positioned with a battery cover for easy replacement of the power source device, and one side of the housing is a protruded button for slidably mounting onto a belt clip, and the driving device is a gear module with a motor to drive the gear module, and one side of the gear module is provided with a tool mount extended beyond the external of the housing for the coupling of the tool connector, and the tool connector is secured with a positioning gear and the housing is mounted with a positioning block for engagement with the positioning gear, and one end of the positioning block is protruded at the external side of the housing.

Yet another object of the present invention to provide a structure of an electrical tool, wherein the protruded button has a protruded ridge having a protruded disc, and the top and bottom side of the protruded disc is formed into a tangential face.

A further object of the present invention to provide a structure of an electrical tool, wherein the belt clip comprises a securing seat having an engaging slot with a width similar to that between two tangential faces on the protruded plates, and the bottom section of the engaging slot is provided with a compartment having a diameter equivalent to that of the protruded disc, and the two lateral walls of the engaging slots and the top section of the compartment is provided with a flange, and a sliding slot is formed between two flanges for the sliding of the protruded ridge.

Other objects, and advantages of the present invention can be more fully understood by reading the following detailed description of the preferred embodiment, with reference to the accompanying.

### BRIEF DESCRIPTION OF THE DRAWINGS

FIG. 1 is a perspective exploded view of a conventional electrical tool.

FIG. 2 is a perspective exploded view of an electrical tool in accordance with the present invention.

FIG. 3 is a perspective view of the electrical tool of FIG. 2, showing the battery being removed, in accordance with the present invention.

FIG. 4 is a sectional view showing the relative position of the positioning block and the positioning gear in accordance with the present invention.

FIG. 5 is a sectional view showing the action of the positioning block with respect to the positioning gear shown in FIG. 4 in accordance with the present invention.

FIG. 6 is a schematic view showing the fastening of a protruded button onto the belt clip in accordance with the present invention.

FIG. 7 is a sectional view in a vertical position of FIG. 6 in accordance with the present invention.

FIG. 8 is a preferred embodiment connected with electrical cable in accordance with the present invention.

FIG. 9 is an exploded perspective view showing the removal of the battery cover located beneath the bottom of the tool in accordance with the present invention.

FIG. 10 is a perspective exploded view showing a battery compartment used in the electrical tool in accordance with the present invention.

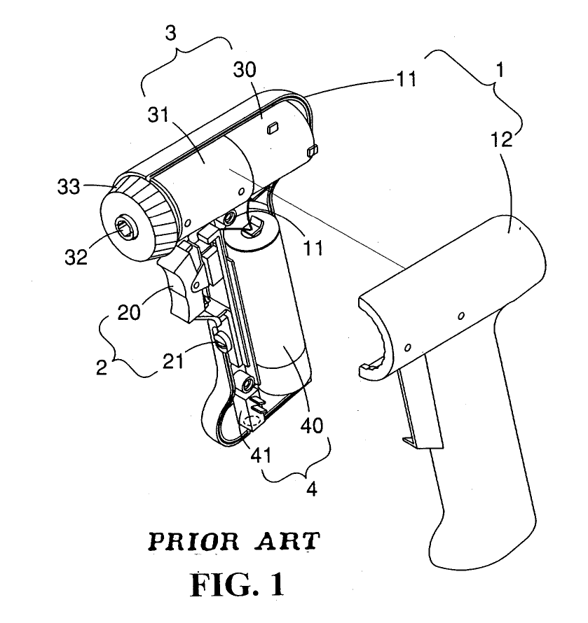

### DETAILED DESCRIPTION OF THE PREFERRED EMBODIMENT

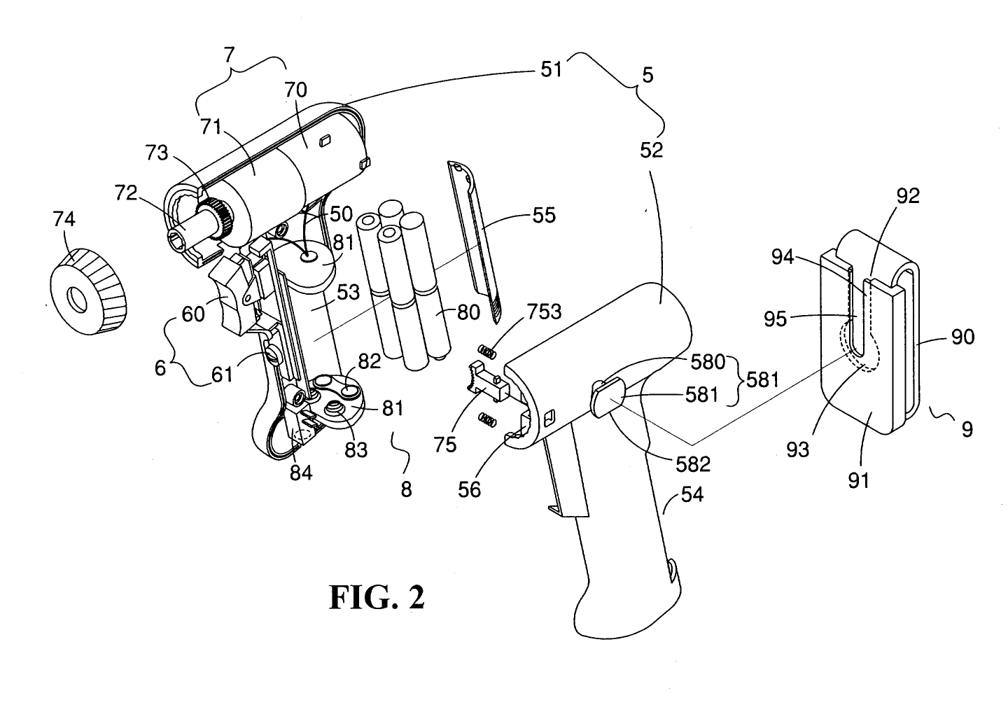

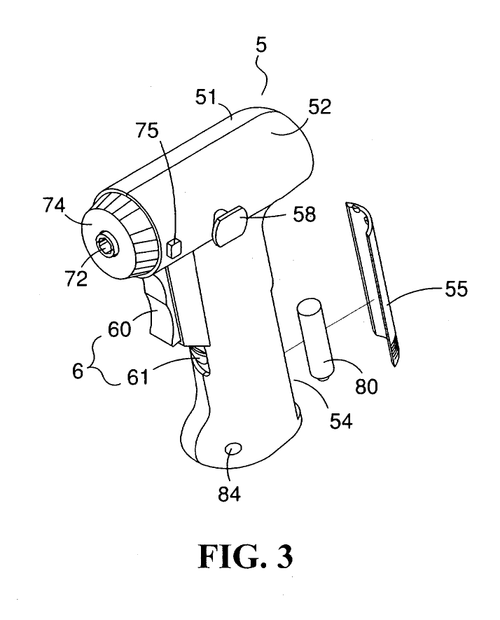

Referring to FIGS. 2 and 3, there is shown a structure of an electrical tool comprising a housing 5 enclosing a control switch 6 connected to a plurality of electrical cables 50, a driving device 7 and a power source device 8.

In accordance with the present invention, the housing 5 comprises a first shell 51 and a second shell 52 of identical shape, combining together to form a compartment for the holding of the control switch 6, the driving device 7 and the power source device 8. The housing 5 is provided with a compartment 53 for holding batteries 80 and one side of the compartment 53 is an opening 54 facilitating the installation of batteries 80. A cover 55 is provided to the opening 54, and the second shell 52 is provided with a holding seat 56 for the placement and sliding of a positioning block 75. The holding seat is provided with a spring slot for holding of a spring, and the positioning block is provided with one end having a pressing section which is exposed outside the housing, and another end of the positioning block is provided with an engaging section having a plurality of teeth, and the two sides of the positioning block are provided with a protruded block for urging the spring.

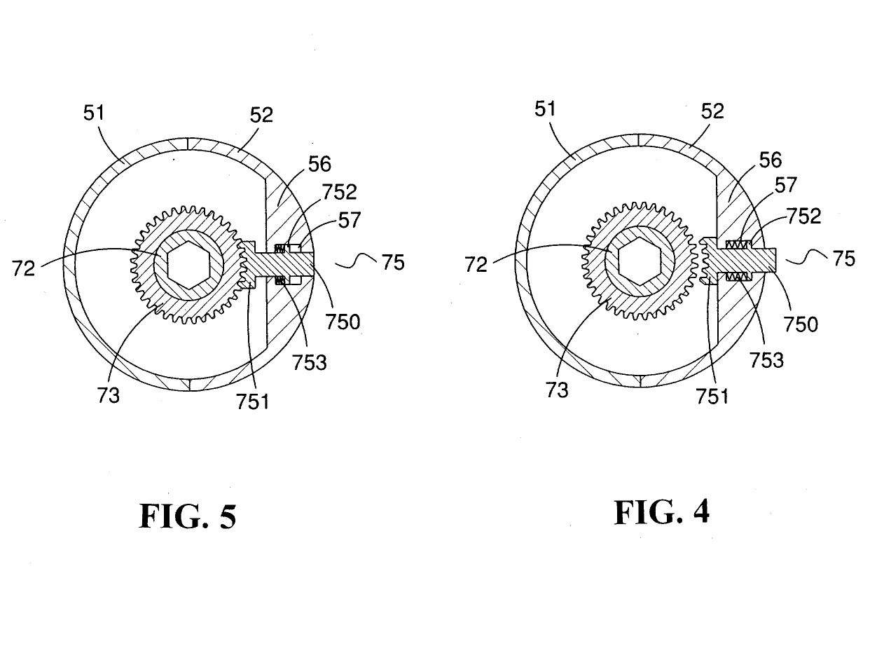

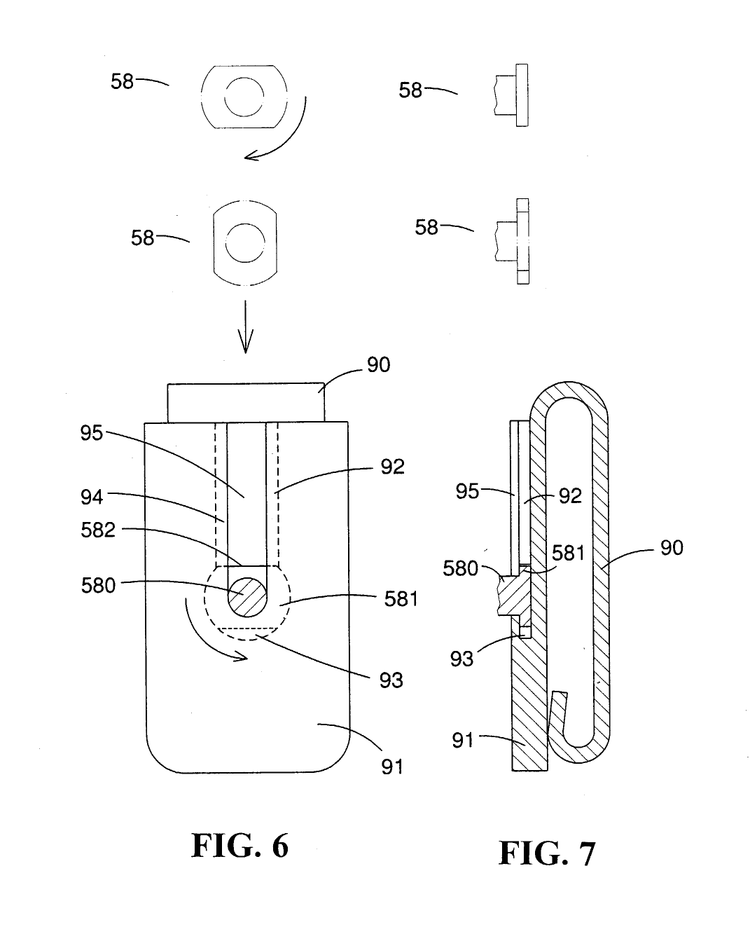

Referring to FIGS. 4 and 5, the second shell 52 is provided with a protruded button 58 and the protruded button has a protruded ridge having a protruded disc, and the top and bottom side of the protruded disc is formed into a tangential face. The belt clip comprises a securing seat having an engaging slot with a width similar to that between two tangential faces on the protruded plates, and the bottom section of the engaging slot is provided with a compartment having a diameter equivalent to that of the protruded disc, and the two lateral walls of the engaging slots and the top section of the compartment is provided with a flange, and a sliding slot is formed between two flanges for the sliding of the protruded ridge, as shown in FIGS. 6 and 7.

The control switch 6 comprises a press button 60 and a locking button 61, and the press button 6 is protruded at one side of a handle positioned on the housing 5, and the locking button 61 is positioned at the bottom section of the press button 60. The control switch control the clockwise and counterclockwise rotation of the electrical tool. The locking button 61 can urge the lower section of the press button 60 which can control the downward pressing of the press button 60.

The driving device 7 is positioned at the top section of the housing 5, and comprises a motor 70, a gear module 71, a tool connector 72 and a front cover 74, and the gear module 71 is positioned at one lateral side of the motor 70 and having a plurality of gears for the driving of the motor, and one end of the gear module 71 is provided with the tool mount 72 for the coupling of a tool connector 72, and the connector 72 is provided with a positioning gear for engaging of a tool connector 72 for mounting with a positioning block 75. The tool connector 72 and the external edge of the positioning teeth 73 are provided with the front cover 74 which mounted within the housing without exposing the cover 74.

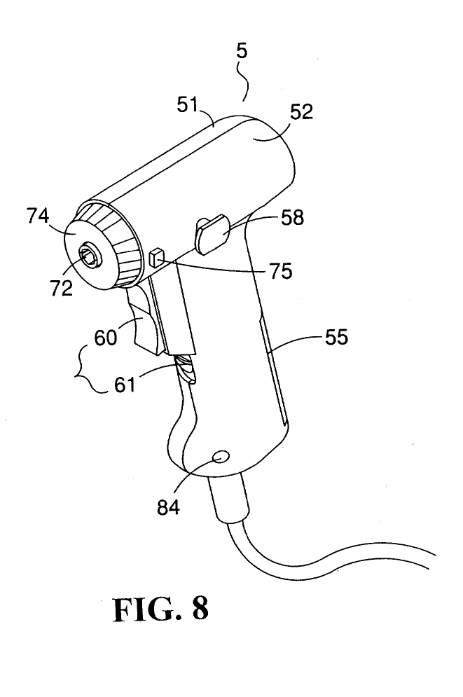

The power source device 8 is located at the compartment 53 formed on the housing 5 for batteries 80, and the power source device is a battery compartment 53 containing batteries 80. A seat plate 81 is protruded from the top and bottom of the compartment 53 and the compartment 53 is connected to the driving device 7, the control switch 6 and the AC socket 84 with electrical cables 50, as shown in FIG. 8.

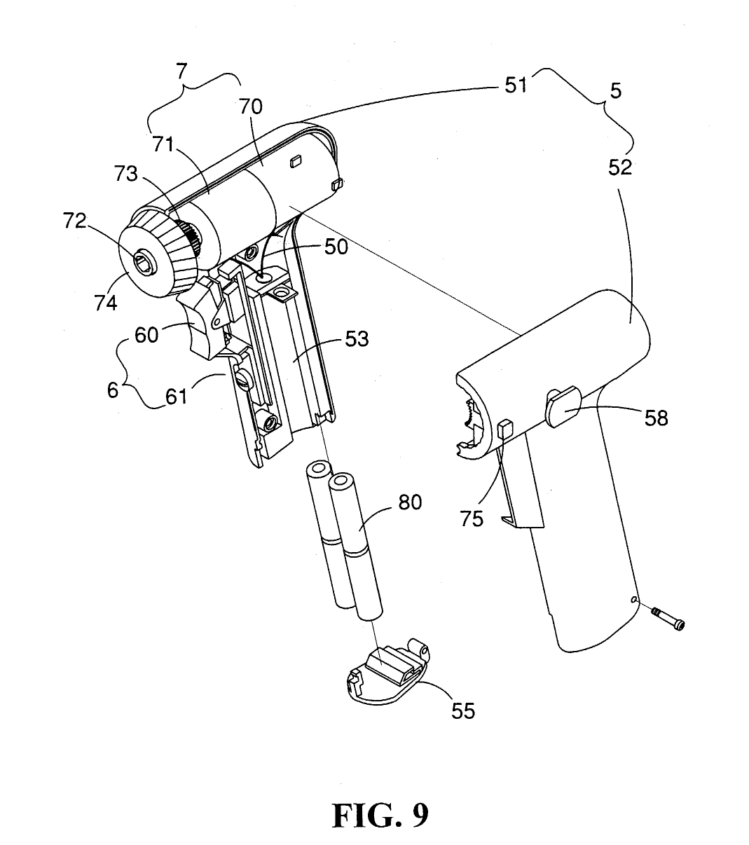

Referring to FIG. 9, the battery cover 55 is secured to the bottom section of the housing 5 and the housing 5 is pivotally mounted, facilitating the installation of batteries 80.

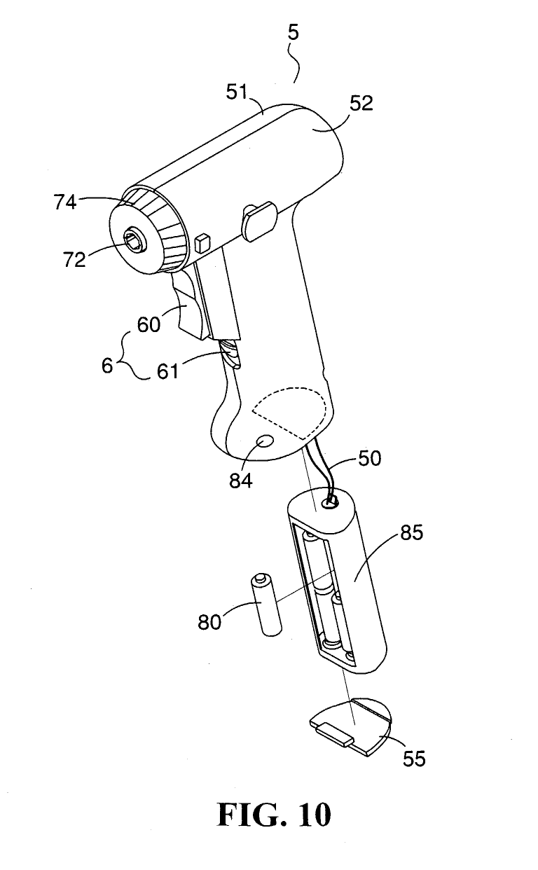

Referring to FIG. 10, the power source device 8 is a battery compartment 85 containing batteries 80 and the compartment 85 is connected to the driving device 7, the control switch 6 and the AC socket 84 with electrical cables 50.

In accordance with the present invention, the advantages of the electrical tool are as follows:

1. The electrical tool can be manually operated by pressing the pressing section 750 so that the engaging section 751 of one end of the positioning block 75 is in engagement with the positioning gear 73.

2. The electrical tool is portable. The structure can be rotated to a 90 degree so that the protruded plate 581 can be engaged to the securing seat 91 and the protruded element 580 will engage with the compartment 93 of the sliding slot 89. This enables the tool to be mounted to a securing seat 91, facilitating the tool to be carried along.

3. The longevity of the batteries is not affected. The battery compartment allows the replacement of all kinds of batteries, and when no in use the batteries can be withdrawn. Thus the life of the batteries is prolonged.

4. The replacement of batteries is rapid. Due to the mounting of the compartment 53 and the opening 54 and one side of the compartment 53, the removal of used batteries is easy and therefore the installation of new batteries is rapid.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A structure of an electrical tool having a housing mounted with a driving device for coupling with a tool connector, and having a control switch for controlling the switching of the driving device, characterized in that a compartment for containing a power source device is provided to the housing, and one side of the housing is positioned with a battery cover for easy replacement of the power source device, and one side of the housing is a protruded button for slidably mounting onto a belt clip, and the driving device is a gear module with a motor to drive the gear module, and one side of the gear module is provided with a tool mount extended beyond the external of the housing for the coupling of the tool connector, and the tool connector is secured with a positioning gear and the housing is mounted with a positioning block for engagement with the positioning gear, and one end of the positioning block is protruded at the external side of the housing.

2. The electrical tool of claim 1, wherein the protruded button has a protruded ridge having a protruded disc, and the top and bottom side of the protruded disc is formed into a tangential face.

3. The electrical tool of claim 1, wherein the belt clip comprises a securing seat having an engaging slot with a width similar to that between two tangential faces on the protruded plates, and the bottom section of the engaging slot is provided with a compartment having a diameter equivalent to that of the protruded disc, and the two lateral walls of the engaging slots and the top section of the compartment is provided with a flange, and a sliding slot is formed between two flanges for the sliding of the protruded ridge.

4. The electrical tool of claim 1, wherein one side of the housing is provided with a holding seat for the movement of the positioning block, and the holding seat is provided with a spring slot for holding of a spring, and the positioning block is provided with one end having a pressing section which is exposed outside the housing, and another end of the positioning block is provided with an engaging section having a plurality of teeth, and the two sides of the positioning block are provided with a protruded block for urging the spring.

5. The electrical tool of claim 1, wherein the top and bottom section of the compartment are each provided with a seat plate having a plurality of positive terminal conductive plates and negative terminal conductive plates, which are connected to the control switch and AC socket.

6. The electrical tool of claim 1, wherein the housing comprises a first shell and a second shell forming a compartment between the shells for holding the control switch, the driving device and the power source device.

7. The electrical tool of claim 1, wherein the control switch comprises a press button and a locking button, and the press button is protruded at one side of a handle positioned on the housing, and the locking button is positioned at the bottom section of the press button.

8. The electrical tool of claim 1, wherein the driving device is positioned at the top section of the housing, and comprises a motor, a gear module, a tool connector and a front cover, and the gear module is positioned at one lateral side of the motor and having a plurality of gears for the driving of the motor, and one end of the gear module is provided with the tool mount for the coupling of a tool connector, and the connector is mounted with the front cover having a through hole for the protruded out of the tool connector.

9. The electrical tool of claim 1, wherein the battery cover is secured to the bottom section of the housing and the housing is pivotally mounted, facilitating the installation of batteries.

10. The electrical tool of claim 1, wherein the power source device is a battery compartment containing batteries and the compartment is connected to the driving device, the control switch and the AC socket with electrical cables.
